(19) United States
(12) Patent Application Publication
(10) Pub. No.: US 2021/0352104 A1
(43) Pub. Date: Nov. 11, 2021

(54) DETECTING MALICIOUS ACTIVITY IN A CLUSTER

(71) Applicant: Tigera, Inc., San Francisco, CA (US)

(72) Inventors: Manish Haridas Sampat, San Jose, CA (US); Garwood Joshua Pang, Vancouver (CA); Chris Gong, Vancouver (CA); Manoj Vijaykant Ahuje, Vancouver (CA)

(21) Appl. No.: 16/916,648

(22) Filed: Jun. 30, 2020

Related U.S. Application Data
(60) Provisional application No. 63/020,348, filed on May 5, 2020.

(51) Int. Cl. H04L 29/06; G06F 9/455

(52) U.S. Cl. CPC H04L 63/1491; H04L 63/1416; H04L 63/0236; G06F 2009/45587; G06F 9/45558; G06F 2009/45595; H04L 63/20

(57) ABSTRACT

Access is provided to a plurality of virtual logical hosts and a decoy resource. Each virtual logical host comprises comprising one or more virtualized containers. A communication sent to the decoy resource is detected. Network communication data with respect to the decoy resource is collected based at least in part on detecting the communication sent to the decoy resource. The network communication data includes metadata used to provide said access via network communications to the decoy resource.

### CROSS REFERENCE TO OTHER APPLICATIONS

This application claims priority to U.S. Provisional Patent Application No. 63/020,348 entitled DETECTING MALICIOUS ACTIVITY IN A CLUSTER filed May 5, 2020 which is incorporated herein by reference for all purposes.

### BACKGROUND OF THE INVENTION

A cluster may be comprised of a plurality of computing nodes (e.g., physical machine, virtual machine hosted on a physical machine). A containerized application may be comprised of a plurality of virtual logical hosts (e.g., pods). A virtual logical host may include one or more virtualized containers. The plurality of virtual logical hosts may be running on one of the computer nodes or distributed across a plurality of the computing nodes. The plurality of virtual logical hosts may communicate with each other to provide the containerized application. The plurality of virtual logical hosts may be vulnerable to an attack. It may be difficult to determine where an attack is occurring in the cluster given the amount of traffic that is communicated between the plurality of virtual logical hosts and the distributed configuration of containerized application.

### BRIEF DESCRIPTION OF THE DRAWINGS

Various embodiments of the invention are disclosed in the following detailed description and the accompanying drawings.

FIG. 1 is a block diagram illustrating an embodiment of a system for detecting malicious activity in a cluster.

FIG. 2 is a block diagram illustrating an example of system for detecting malicious activity in a cluster in accordance with some embodiments.

FIG. 3 is a block diagram illustrating a system for selective scanning of network traffic in accordance with some embodiments.

FIG. 4 is a flow chart illustrating a process for deploying decoy resources in accordance with some embodiments.

FIG. 5 is a flow chart illustrating a process for detecting malicious activity in a cluster in accordance with some embodiments.

FIG. 6 is a flow chart illustrating a process for performing mitigation actions in accordance with some embodiments.

FIG. 7 is a flow chart illustrating a process for selectively network scanning in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques to detect malicious activity within a cluster, in various embodiments, are disclosed. The malicious activity detection techniques disclosed herein enable a containerized application to be monitored without overburdening the resources of the cluster. A containerized application is comprised of one or more virtual logical hosts that each include one or more virtualized containers. The one or more virtual logical hosts are deployed to one or more computing nodes (e.g., physical server, virtual machine hosted on a physical server) of a cluster. An entity (e.g., user, enterprise, company, government, institution, etc.) may request an instance of a containerized application be deployed to the cluster according to a manifest. The manifest may indicate a configuration for the containerized application (e.g., the number of virtual logical hosts, a number of virtualized containers needed within a virtual logical host, the types of virtual logical hosts and/or virtualized containers needed, which virtual logical hosts communicate with which virtual logical hosts, which virtualized containers communicate with which virtualized containers, etc.).

Each computing node of the cluster has a corresponding management controller. A management controller may analyze the manifest and determine where, how many, how long, and the type of decoy resources to deploy to a computing node. The management controller may implement a recommendation engine, a rule-based model, a machine learning model, etc., to make the determination. The management controller includes an intrusion detection system (IDS) engine that is configured to analyze communication data associated with a decoy resource for malicious activity and report malicious activity.

A decoy resource may be a virtual logical host or a virtualized container, but does not contribute to the overall objective of the containerized application. For example, the containerized application may be a database application and the decoy resource may be an empty database. The main purpose of a decoy resource is to provide a detection mechanism for any malicious activity within the cluster and to divert a malicious actor's focus towards gaining access to the decoy resource instead of the actual sensitive resources in the cluster. The decoy resource may have a name that is similar (within a threshold amount) to legitimate virtual logical hosts or virtualized containers associated with the containerized application. This may cause the malicious actor to believe that the decoy resource is a legitimate virtual logical host or virtualized container of the containerized application.

The management controller may generate one or more decoy resources and deploy the one or more decoy resources to a computing node. In normal operation of the containerized application, a legitimate virtual logical host (e.g., not compromised) or legitimate virtualized container does not communicate with a decoy resource. However, a subset of the virtual logical hosts or virtualized containers may be configured to communicate with a decoy resource. Communications within a containerized application may be controlled through the use of metadata.

Metadata (e.g., tag(s), label(s), key-value pair(s), etc.) may be attached to the one or more decoy hosts, the one or more virtual logical hosts, and/or the one or more virtualized containers prior to the being deployed to the one or more computing nodes. The attached metadata may be associated with one or more policies. A policy may indicate other virtual logical hosts, virtualized containers, decoy resources, and/or endpoints to which a virtual logical host, virtualized container, or decoy resource is permitted to communicate. For example, a policy may indicate that a virtualized container with a “red” label with a key-value pair of “role:production” is permitted to communicate with other virtualized containers having the “red” label and the key-value pair of “role:production.” The metadata attached to a decoy resource indicates the one or more virtual logical hosts and/or virtualized containers that are permitted to communicate with the decoy resource.

Access vectors to a decoy resource may be controlled to allow a malicious actor's location within the cluster and the compromised virtual logical host/virtualized container to be easily identified. A decoy resource may intentionally have a weak password to entice a malicious actor to gain access to the decoy resource. After gaining access, the malicious actor may waste time trying to exploit the decoy resource instead of compromising other legitimate virtual logical hosts or legitimate virtualized containers of the computing node. The number of virtual logical hosts and/or virtualized containers that have the same label, tag, or key-value pair as the decoy resource may be limited to a small number (e.g., less than a threshold) so that a compromised virtual logical host or compromised virtualized container may be easily identified. That is, if a decoy resource is accessed, the number of potential virtual logical hosts or virtualized containers that may be suspected to have communicated with the decoy resource is small (e.g., 1 or 2).

A device associated with a malicious actor outside of the cluster may access the containerized application. The malicious actor's device may gain access and control of a virtual logical host and/or a virtualized container. The one or more virtual logical hosts and virtualized containers of a computing node are located on the same network (e.g., subnet). Because the malicious actor is unaware of the containerized application configuration; after the malicious actor's device gains access to a virtual logical host or a virtualized container, the malicious actor's device may scan for neighboring virtual logical hosts and/or virtualized containers to determine one or more virtual logical hosts and/or virtualized containers that are in communication with virtual logical host or virtualized container that the malicious actor has accessed. The scan may identify the decoy resource and the malicious actor may attempt to access the decoy resource. The malicious actor may believe the decoy resource is a legitimate resource of the containerized application because the name of the decoy resource is similar to other virtual logical hosts and/or virtualized containers of the containerized application.

The decoy resource may be configured to notify a management controller of any network communication received at the decoy resource. The decoy resource may also be configured to collect any information associated with a received network communication data (e.g., packet capture). The information may include metadata associated with a received network communication data, such as a source interne protocol (IP) address, a source port, a destination IP address, a destination port, a protocol used, a cluster identity, a namespace identity, a virtualized logical host identity, a label, and/or network metrics associated with the network communication data (e.g., number of bytes and packets), etc. The information may also include the data packets of the network communication data. The decoy resource may provide the management controller the collected information.

In response to receiving a notification from a decoy resource, the management controller is configured to perform a responsive action, such as generating an alert for one or more other systems or services, such as a network security system or a logging system, to notify a cluster operator of the malicious activity. The management controller may use an IDS engine to analyze the collected information. The IDS engine may extract a payload from the data packets of the network communication data to determine a type of exploit that the malicious actor is attempting to execute on the computing node.

The management controller may also perform a responsive action, such as mitigating a compromised virtual logical host or compromised virtualized container through the use of metadata and/or policies. In some embodiments, metadata, such as a label, tag, or key-value pair, is attached the compromised virtual logical host or compromised virtualized container. A policy associated with the attached metadata may indicate that the compromised virtual logical host or compromised virtualized container is not permitted to communicate with other virtual logical hosts or virtualized containers. In some embodiments, the metadata is already attached to the compromised virtual logical host or compromised virtualized container and a policy associated with the metadata is updated to indicate that a virtual logical host or virtualized container having the metadata is no longer permitted to communicate with other virtual logical hosts or virtualized containers.

It is possible that a malicious actor may gain access to part of a containerized application at which a decoy resource has not been deployed. It may not be practical for the management controller to scan all of the network communication data because the amount of network communication data sent within a containerized application is significant. As an additional protective measure, the management controller may selectively scan parts of the containerized application to determine if a virtual logical host has been compromised. In response to determining that the virtual logical host has been compromised, the management controller may perform one or more responsive actions as described herein.

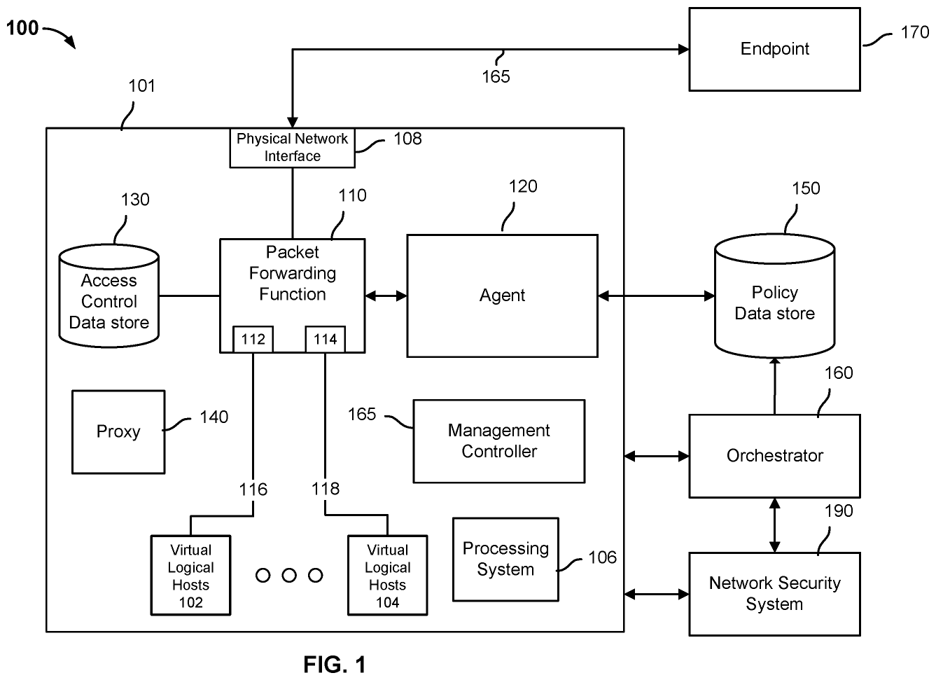

FIG. 1 is a block diagram illustrating an embodiment of a system for detecting malicious activity in a cluster. The system for detecting malicious activity in a cluster is comprised of a plurality of computing nodes that are networked together via a network connection. Although system 100 depicts a single computing node 101, system 100 may include n computing nodes. Each of the n computing nodes may be configured in a similar manner to computing node 101. The cluster of computing nodes may be located in one or more datacenters, a cloud environment, or a combination of the two.

Computing node 101 is comprised of one or more virtual logical hosts 102, 104, processor 106, physical network interface 108, packet forwarding function 110, agent 120, access control data store 130, proxy 140, and management controller 165. Computing node 101 may be a physical server or a virtual machine hosted on a physical server.

Computing node 101 includes one or more virtual logical hosts 102, 104. Although FIG. 1 depicts computing node 101 as having two virtual logical hosts, computing node 101 may include n virtual logical hosts. A virtual logical host may be a pod, a secret, a service, etc. A virtual logical host may include one or more virtualized containers. A virtual logical host or a virtualized container may be referred to as a “virtual resource unit.”

A virtual logical host or a virtualized container can be associated with metadata (e.g., tag(s), label(s), key-value pair(s), etc.) that is attached to it by orchestrator 160 or via other mechanisms. For example, a virtual logical host or a virtualized container can have a label, such as “red” or “blue,” or have a key-value pair (KVP), such as “role: production” or “role: development.” The metadata associated with a virtual logical host or a virtualized container follows the virtual logical host or the virtualized container around the cloud as the virtual logical host or the virtualized container is instantiated, moved, destroyed, scaled up, and/or scaled down.

The metadata can be referenced by one or more policies. A policy can reflect an intent of how one or more associated virtual logical hosts or virtualized containers are to be used within a computing environment. For example, a policy can indicate that virtual logical host or a virtualized container with a “red” label and a KVP of “role: production” can access a “red_db” server, whereas virtual logical host or virtualized containers with a “blue” label and a KVP of “role: production” are not be able to access the “red_db” server, but are able to access a “blue_db” server.

Computing node 101 can include processing system 106. The processing system can be comprised of one or more processors and/or memory. Computing node 101 can include a physical network interface 108. Physical network interface 108 is configured to receive one or more data packets from one or more endpoints 170 and to forward the one or more data packets to packet forwarding function 110. In some embodiments, physical network interface 108 is configured to forward one or more data packets received from packet forwarding function 110 to one of the one or more endpoints 170. In some embodiments, physical network interface 108 is configured to forward one or more data packets received from packet forwarding function 110 to another computing node of the cluster. Physical network interface 108 can comprise one or more network interface cards.

Computing node 101 can include packet forwarding function 110, which is configured to forward data packets that may be routed to and/or from the virtual logical hosts 102, 104. In some embodiments, packet forwarding function 110 forwards packets from virtual logical host 102 to virtual logical host 104 and vice versa. In some embodiments, packet forwarding function 110 forwards packets from virtual logical hosts 102, 104 to one or more endpoints 170. In other embodiments, packet forwarding function 110 forwards packets from one or more endpoints 170 to virtual logical hosts 102, 104. Packet forwarding function 110 can be considered to behave as a virtualized router within computing node 101. By making forwarding decisions for the received packets on the basis of the destination IP address, packet forwarding function 110 can be considered to operate at “Layer 3” of the OSI model. Packet forwarding function 110 may have an IP address in the internal network that is different to the IP address that it has in an external network. The IP address of packet forwarding function 110 in the external network may be the same as an IP address of computing node 101. The IP address of packet forwarding function 110 in the internal network comprised within computing node 101 is the IP address observed by virtual logical hosts 102, 104.

Packet forwarding function 110 can be comprised of one or more virtual interfaces 112, 114, with a respective virtual connection 116, 118 connecting a respective virtual logical host 102, 104 to packet forwarding function 110. In some embodiments, packet forwarding function 110 is comprised within a Linux kernel running on computing node 101. In some embodiments, virtual interfaces 112, 114 can comprise a virtual Ethernet port, a network tunnel (tun), or a network tunnel (tap). Each of the virtual logical hosts 102, 104 have a corresponding destination IP address and a corresponding destination port.

Computing node 101 can include agent 120. In some embodiments, agent 120 is configured to analyze the metadata associated with a virtual logical host or a virtualized container and to retrieve from policy data store 150 one or more policies associated with the metadata. In other embodiments, agent 120 is configured to determine one or more endpoints associated with a policy. For example, a policy can indicate that a virtual logical host with a “red” label is permitted to communicate with a server having a “red_db” label. Agent 120 can receive a list of servers associated with a “red_db” label from policy data store 150 and update an access control list (ACL) stored in access control data store 130 to reflect the one or more servers with a “red_db” label to which a virtual logical host with a “red” label is permitted to communicate.

In some embodiments, agent 120 is configured to subscribe to updates from policy data store 150. When an update occurs to any of the policies stored in policy data store 150, agent 120 may receive the update and make corresponding updates to the ACL stored in access control data store 130. For example, a policy can be updated to change a role associated with a virtualized container with a “red” label from “development” to “production.” The policy may indicate that a virtualized container with a “red” label having a “development” role has been updated to a “production” role, such that the virtualized container was previously able to communicate with a server with a “red db dev” label, but now is able to communicate with a server with a “red dbprod” label instead of the server with a “red_db_dev” label.

In some embodiments, orchestrator 160 receives an indication that a virtual logical host or a virtualized container has been compromised and updates a policy associated with the compromised virtual logical host or the compromised virtualized container. For example, orchestrator 160 may receive the indication from management controller 165 or network security system 190. Agent 120 may receive the updated policy and update the ACL by removing entries associated with the compromised virtual logical host or compromised virtualized container. This prevents the compromised virtual logical host or compromised virtualized container from communicating with other virtual logical hosts, virtualized containers, or endpoints.

Computing node 101 can include an access control data store 130. Access control data store 130 can comprise an ACL that includes entries of IP addresses that are allowed to communicate with a particular virtual logical host or a particular virtualized container and entries of IP addresses to which the particular virtual logical host or the particular virtualized container are allowed to communicate. The IP addresses can be explicitly or implicitly specified by one or more policies. For example, an entry of the ACL may indicate a particular virtual logical host is permitted to communicate with an endpoint having a particular IP address. A policy may indicate that a virtualized container with a “red” label and a KVP of “role: production” can access a “red_db” server. The ACL can be updated to store the IP addresses of all servers associated with a “red db” label. This will allow the virtualized container with the “red” label and a KVP of “role: production” to access any of the “red_db” servers with an IP address stored in the ACL. In some embodiments, a policy can indicate a specific port forward traffic from a virtualized container to an endpoint. In some embodiments, a policy can indicate that a virtualized container with a particular label can receive traffic via a specific port (e.g., port 8080). Access control data store 130 can comprise an ACL that includes entries of API endpoints that are allowed to communicate with a particular virtual logical host or a particular virtualized container and entries of API endpoints to which the particular virtual logical host or the particular virtualized container is allowed to communicate.

In some embodiments, access control data store 130 is updated on a periodic basis. In other embodiments, access control data store 130 is updated by agent 120 upon agent 120 detecting a change to one of the policies stored in policy data store 150. In other embodiments, agent 120 is configured to subscribe to policy data store updates and to update the access control data store 130 based on the updates.

Computing node 101 can include one or more proxies 140. A proxy can be configured to enforce a policy associated with one or more virtual logical hosts or one or more virtualized containers. A proxy can be a sidecar proxy—actually included as part of a virtual logical host or a virtualized container, an external proxy dedicated to a specific virtual logical host or a specific virtualized container, or a shared proxy for a plurality of virtual logical hosts or a plurality of virtualized containers. In other embodiments, the proxy can be a remote proxy located on a different host. In other embodiments, the proxy can be located in a virtual logical host or a virtualized container. In other embodiments, the proxy can be proxy located in packet forwarding function 110 (e.g., Linux kernel, user space daemon). In some embodiments, a policy can indicate that traffic between a virtual logical host or a virtualized container, and an endpoint is to travel through proxy 140. In other embodiments, a policy can indicate that traffic between a virtual logical host or a virtualized container, and an endpoint does not need to travel through proxy 140.

Computing node 101 is coupled to policy data store 150. Policy data store 150 is coupled to each of the computing nodes of the cluster. Policy data store 150 may be part of the cluster or external to the cluster. Policy data store 150 is configured to store a plurality of policies. A policy can be associated with one or more virtual logical hosts or one or more virtualized containers. A virtual logical host can be associated with one or more different policies. A virtualized container can be associated with one or more different policies. Policy data store 150 is coupled to orchestrator 160.

In some embodiments, orchestrator 160 is configured to setup and deploy the one or more virtual logical hosts 102 to computing node 101 based on a manifest provided by an entity. The manifest may indicate a configuration for the containerized application (e.g., the number of virtual logical hosts, a number of virtualized containers needed within a virtual logical host, the types of virtual logical hosts and/or virtualized containers needed, which virtual logical hosts communicate with which virtual logical hosts, which virtualized containers communicate with which virtualized containers, etc.). Orchestrator 160 can assign an IP address to a virtual logical host when setting up the virtual logical host. In some embodiments, orchestrator 160 is part of computing node 101.

Orchestrator 160 can be configured to attach metadata to a virtual logical host or a virtualized container. The metadata can be a tag, label, key-value pair, etc. In some embodiments, orchestrator 160 is configured to update any of the one or more policies stored in policy data store 150. In other embodiments, orchestrator 160 is configured to modify some or all of the metadata that is attached to a virtual logical host or a virtualized container. In some embodiments, orchestrator 160 is configured to attach additional metadata to a virtual logical host or a virtualized container. In some embodiments, orchestrator 160 is configured communicate with policy data store 150 via a plugin (e.g., translation mechanism such as a neutron worker (in OpenStack) or CNI plugin (in the container networking interface model)). In some embodiments, orchestrator 160 is configured to close any of the one or more virtual logical hosts 102, 104 on computing node 101 and to update any of the policies associated with the closed virtual logical hosts.

Computing node 101 is coupled to endpoint 170 via network connection 165. Network connection 165 can be a local area network, a wide area network, a wired network, a wireless network, the Internet, an intranet, or any other appropriate communication network. Endpoint 170 can receive network communication data to/from computing node 101. Endpoint 170 can be a computing device, a server, a laptop, a desktop, a mobile device, a tablet, a smart device, database server, an API server, or any other type of computing device external to computing node 101. In some embodiments, endpoint 170 is a computing device associated with a malicious actor.

Management controller 165 may receive a manifest that indicates a configuration for the containerized application. Management controller 165 may receive the manifest from orchestrator 160 or from an entity associated with the manifest. Management controller 165 may analyze the manifest and determine where, how many, how long, and the type of decoy resources to deploy to computing node 101. Management controller 165 may implement a recommendation engine, a rule-based model, a machine learning model, etc., to make the determination. The recommendation engine may recommend the decoy resources based on current and/or past states of the cluster. The recommendation engine may recommend decoy resources before an initial set of one or more decoy resources are deployed to computing node 101. The recommendation engine may recommend one or more additional decoy resources after the initial set is deployed to computing node 101, that is, the recommendation engine may recommend additional decoy resources be deployed to computing node 101 after the containerized application has started running in the cluster that includes computing node 101.

The recommended decoy resources are those most suitable for the detection of malicious activities deemed as high risk to the cluster. The recommendation engine may take as inputs the event driven behavior of the clusters, the state of the clusters, and prior data related to the clusters. These inputs can include, but are not limited to, cluster alerting and anomaly detection systems, flow logs, DNS logs, audit logs, and existing cluster policies. The recommended decoy resources are derived from the inputs and a recommendation model. The recommendation model can be a rule based model and/or machine learning model (e.g., linear regression, logistic regression, decision tree, support vector machine, Naive Bayes, kNN, K-Means, Random Forest, deep learning, etc.). The recommendation model may be used to infer causation or ordering of cluster activities.

The recommendation engine may also select for scanning a virtual logical host of the plurality of virtual logical hosts. It may not be practical for the management controller to scan all of the network communication data associated with computing node 101 because the amount of network communication data sent within computing node 101 is significant. As an additional protective measure, the management controller may selectively scan, based on a recommendation from the recommendation engine, parts of the containerized application to determine if a virtual logical host has been compromised.

Management controller 165 includes an IDS engine that is configured to scan communication data associated with a decoy resource for malicious activity and report malicious activity. This allows the engine to operate on network communication data that is already identified to be suspicious and hence is very efficient in generating high fidelity alerts. The IDS engine may be a pluggable engine. Management controller 165 may determine which network flow should be scanned and for how long. Management controller 165 may generate an alert to other systems or services, such as network security system 190, to notify a cluster operator of the malicious activity. In some embodiments, management controller 165 performs selective network scanning by implementing a traffic mirroring and/or redirection capability application that is attached to the target virtual logical host's virtual interface (e.g., virtual interface 112, 114). The application can send specific flow or protocol's traffic to the IDS engine, which then scans the packets for malicious traffic. Management controller 165 may attach to a decoy resource or one of the virtual logical hosts 102, 104 to extract the payload of data packets, as well as redirect malicious packets to a sinkhole, or redirect legitimate packets back to the intended service (e.g., away from a malicious actor).

Management controller 165 may be used as an intermediary storage of packet captures and alerts that are generated by the IDS engine. Management controller 165 may also handle the management of ongoing network scan and the target interfaces. Management controller 165 may access the host network (the network that connects the plurality of computing nodes) in order to modify the underlying network.

Management controller 165 is configured to control the deployment and management of decoy resources. Management controller 165 may include an anomaly detection engine that leverages information about the cluster, network activity, and other network security capabilities to proactively deploy/remove decoy resources and trigger network scans. When any suspicious activity is detected, either by a network packet scan or a connection to a decoy resource, an alert is generated and provided to network security system 190.

Network security system 190 may include a logging system that is configured to store in a plurality of logs. A log may include a plurality of entries corresponding to a plurality of alerts received from a computing node. The log provides rich context information, including a correlation between a virtual logical host IP address/port and cluster information, such as virtual logical host identity (metadata, name, labels, etc.) for each log. This enables easy identification of the virtual logical host or virtualized container that is making a connection to the decoy resource.

Network security system 190 may update one or more policies associated with the identified virtual logical host or identified virtualized container. For example, network security system 190 may cause a policy associated with the identified virtual logical host or identified virtualized container that is stored in policy data store 150 to be updated. In some embodiments, network security system 190 may cause additional metadata to be attached to the identified virtual logical host or identified virtualized container. The additional metadata indicate that the identified virtual logical host or identified virtualized container is compromised and should not permitted to communicate with other virtual logical hosts or virtualized containers.

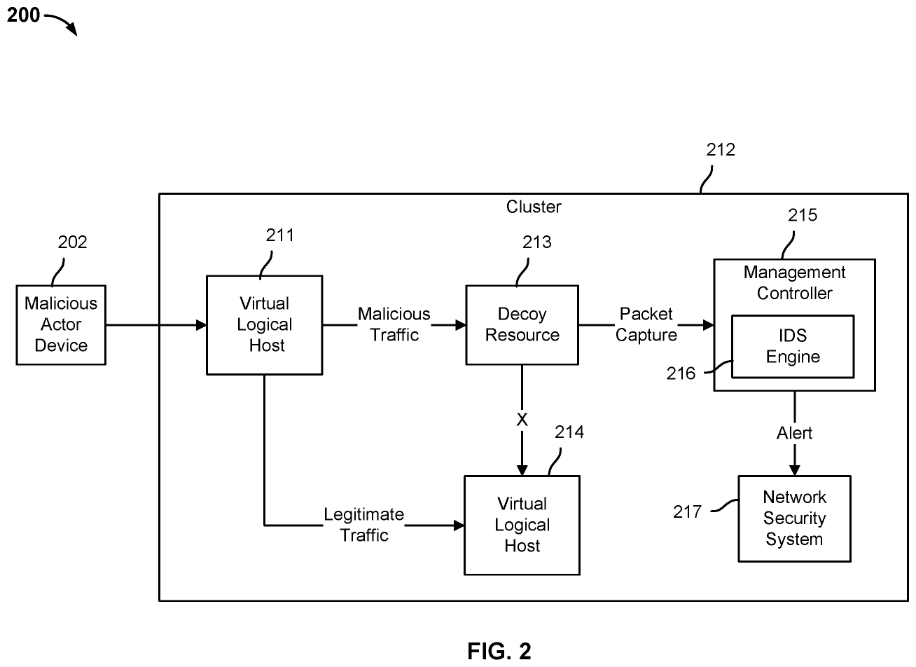

FIG. 2 is a block diagram illustrating an example of system for detecting malicious activity in a cluster in accordance with some embodiments. In the example shown, system 200 may be implemented by one or more computing nodes, such as computing node 101.

In the example shown, a cluster 212 that includes virtual logical host 211, decoy resource 213, virtual logical host 214, management controller 215 that includes an IDS engine 216, and network security system 217. Virtual logical host 211, decoy resource 213, virtual logical host 24, management controller 215, and network security system 217 may located on a single computing node or spread across a plurality of computing nodes.

Virtual logical host 211, decoy resource 213, and virtual logical host 214 may communicate with each other via an internal network of cluster 212. Virtual logical host 211, decoy resource 213, and virtual logical host 214 may be on the same subnet of the internal network of cluster 212. Legitimate traffic received at virtual logical host 211 may be sent to virtual logical host 214.

Decoy resource 213 may be prevented from communicating with virtual logical host 214. Communications within cluster 212 may be controlled through the use of one or more policies. For example, a policy may indicate that virtual logical hosts having the same label are permitted to communicate with each other. A policy may indicate that virtual logical hosts having different labels are not permitted to communicate with each other. Decoy resource 213 and virtual logical host 214 may have different labels whereas virtual logical host 211 and virtual logical host 214 have the same label.

A malicious actor device 202 may gain access to virtual logical host 211. For example, virtual logical host 211 may be a frontend virtual logical host associated with a containerized application. Malicious actor device 202 may have gained control of virtual logical host 211. A malicious actor associated with malicious actor device 202 may not have any prior knowledge about cluster 212 and its virtual logical hosts. After malicious actor device 202 gains control of virtual logical host 211, malicious actor device 202 may scan (e.g., port scan, IP address scan, MAC address scan, etc.) the internal network of cluster 212 to determine one or more neighboring virtual logical hosts of virtual logical host 211. Malicious actor device 202 may attempt to gain access to any of the determined neighboring virtual logical hosts. Decoy resource 213 may have a name that is similar to other legitimate virtual logical hosts of cluster 112 to entice a potential attacker. For example, virtual logical host 214 may have a name of “backend.mysql” and decoy resource 213 may have a name of “mysql.debug.”

Malicious actor device 202 may send one or more data packets to each of the one or more determined neighboring virtual logical hosts. A data packet may be comprised of a header and a payload. The payload may include a script or program to gain control of a virtual logical host, a virtualized container, or a decoy resource. Malicious actor device 202 may gain access to decoy resource 213. Decoy resource 213 may send to management controller 215 a notification that an entity (e.g., malicious actor device 202) has communicated with decoy resource 213. In response to receiving the notification, management controller 215 may collect the network communication data (e.g., the one or more data packets) that are sent to decoy resource 213 from malicious actor device 202. Management controller 215 may store information about the network communication data and/or provide the information about the network communication data to network security system 217. The information may be stored in a flow log that includes an entry for each captured data packet. The entry may include information such as source port, destination port, source IP address, destination IP address, packet size, labels, metadata, policy group, etc. The information may be used to identify malicious actor device 202, determine a type of attack/exploit used by malicious actor device 202, determine whether the attack is static or dynamic, etc.

IDS engine 216 may extract the payload from a data packet and analyze the extracted payload and output an alert to network security system 217 in the event IDS engine 216 determines that the extracted payload is indicative of malicious activity or a policy violation. The payload can be decoded and analyzed to determine the type of exploit that malicious actor device 202 is trying to perform.

Network security system 217 may include a logging system that is configured to store in a plurality of logs. A log may include a plurality of entries corresponding to a plurality of alerts received from a computing node. Network security system 217 may update one or more policies associated with a compromised virtual logical host or a compromised virtualized container. Network security system 217 may cause additional metadata to be attached to a compromised virtual logical host or a compromised virtualized container.

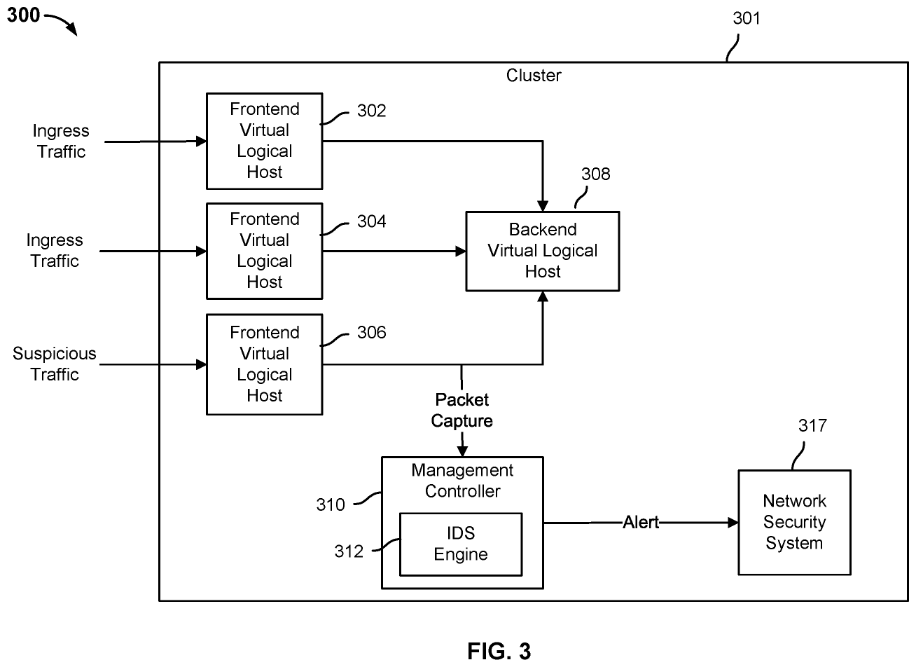

FIG. 3 is a block diagram illustrating a system for selective scanning of network traffic in accordance with some embodiments. In the example shown, system 300 may be implemented by a computing node, such as computing node 101. It may not be practical for a management controller to scan all of the network communication data associated with a computing node because the amount of network communication data sent within the computing node is significant. A management controller may selectively scan parts of cluster 301 to determine if a virtual logical host has been compromised.

System 300 is comprised of cluster 301 that includes frontend virtual logical hosts 302, 304, 306, backend virtual logical host 308, management controller 310, and network security system 317. A decoy resource, such as decoy resource 213 of FIG. 2, may not be able to be deployed to some parts of cluster 301, but management controller 310 may selectively scan network traffic inside cluster 301 for suspicious activity. Management controller 310 may selectively scan network traffic associated with a virtual logical host by implementing a traffic mirroring and/or redirection capability application that is attached to the target virtual logical host's virtual interface. For example, the traffic mirroring and/or redirection capability application may be attached to virtual interfaces 112, 114 of FIG. 1. A recommendation engine associated with management controller 310 may recommend that one or more locations within cluster 301 to scan for network communication data, such as network communication data associated with frontend virtual logical host 306.

In the example shown, a deployment of a containerized application to cluster 301 includes three frontend virtual logical hosts and one backend virtual logical host. The number of frontend virtual logical hosts and backend virtual logical hosts may be specified in a manifest that indicates a configuration for the containerized application (e.g., the number of virtual logical hosts, a number of virtualized containers needed within a virtual logical host, the types of virtual logical hosts and/or virtualized containers needed, which virtual logical hosts communicate with which virtual logical hosts, which virtualized containers communicate with which virtualized containers, etc.).

Frontend virtual logical hosts 302, 304 are receiving normal ingress traffic. In some embodiments, the ingress traffic may be received from an endpoint outside of cluster 301. In some embodiments, the ingress traffic is received from another computing node (not shown) of cluster 301. Frontend virtual logical host 306 is receiving suspicious traffic. The suspicious traffic may be received from an endpoint outside of cluster 301, such as from a device associated with a malicious actor. Frontend virtual logical host 306 may be a compromised virtual logical host (e.g., the device associated with the malicious actor has gained control over frontend virtual logical host 306).

The manifest associated with a containerized application enables frontend virtual logical hosts 302, 304, 306 to communicate with vulnerable backend virtual logical host 308. For example, metadata (e.g., tag, label, key-value pair) may be attached to frontend virtual logical hosts 302, 304, 306 and backend virtual logical host 308. A policy associated with the attached metadata may indicate that frontend virtual logical hosts 302, 304, 306 are permitted to communicate with backend virtual logical host 308.

A behavior associated with frontend virtual logical host 306 may be determined to be suspicious (e.g., through machine learning or anomaly detection). For example, the amount of network communication data sent from frontend virtual logical host may exceed a baseline amount by a threshold amount. The type of network communication data sent from frontend virtual logical host may deviate from an expected type. A frontend virtual logical host may be communicating with other virtual logical hosts to which the frontend virtual logical host is not configured to communicate. A backend virtual logical host may repeatedly restart after a frontend virtual logical host sends a request to it.

During normal operation of the containerized application, management controller 310 may not continuously monitor the network communication data associated with frontend virtual logical host 306. However, in some embodiments, management controller 310 periodically (e.g., once an hour, once a day, once a week, etc.) monitors the behavior associated with a virtual logical host to determine whether the behavior is suspicious. In some embodiments, in response to a recommendation from a recommendation engine associated with management, controller 310, management controller 310 (e.g., in response to detecting suspicious behavior) selectively monitors the behavior associated with a virtual logical host to determine whether the behavior is suspicious. In response to a determination that a behavior associated with frontend virtual logical host 306 is suspicious, management controller 310 may scan the network communication data associated with frontend virtual logical host 306.

Management controller 310 may tap into the connection (e.g., at a virtual interface associated with frontend resource 306) between frontend resource 306 and backend resource 308, and collect network communication data (e.g., capture data packets) sent between the resources. Management controller 310 stores information about the data packet and/or provides the information about the data packet to network security system 317. The information may be stored in a flow log that stores an entry for each captured data packet. An entry may include information such as source port, destination port, source IP address, destination IP address, packet size, labels, metadata, policy group, etc.

The IDS system 312 of management controller 310 may extract the payload from the data packet and analyze the extracted payload. For example, frontend virtual logical host 306 may receive web traffic and determine a uniform resource location (URL) associated with the web traffic and/or a hypertext transfer protocol (HTTP) header associated with the web traffic. The payload may include a HTTP GET method, HTTP POST method, or other HTTP methods, and include an exploit. The exploit may include a script.

IDS system 312 may analyze the extracted payload and output an alert to network security system 317 in the event IDS system 312 determines that the extracted payload is indicative of malicious activity or a policy violation. In response to receiving the alert, network security system 317 may cause the metadata attached to frontend virtual logical host 306 to be updated. For example, network security system 317 may send to an orchestrator associated with cluster 301 or to management controller 310 a command attach a “quarantine” label to frontend virtual logical host 306. A policy associated with a “quarantine” label may be stored in a policy data store. The policy may indicate that any virtual logical host or virtualized container with a “quarantine” label is not permitted to communicate with other virtual logical hosts or virtualized containers of cluster 301. An agent, such as agent 120, may be configured to subscribe to updates in a policy data store and update one or more entries of an access control data store based on the policy.

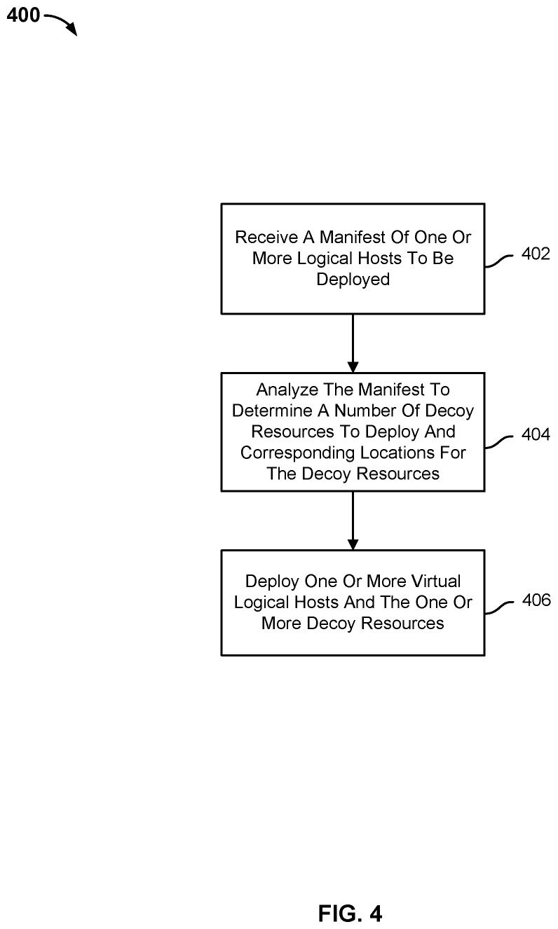

FIG. 4 is a flow chart illustrating a process for deploying decoy resources in accordance with some embodiments. In the example shown, process 400 may be implemented by a management controller, such as management controllers 165, 215, 310.

At 402, a manifest is received. An entity (e.g., user, enterprise, company, etc.) may request an instance of a containerized application be deployed to a cluster according to a manifest. The manifest may indicate a configuration for the containerized application (e.g., the number of virtual logical hosts, a number of virtualized containers needed within a virtual logical host, the types of virtual logical hosts and/or virtualized containers needed, which virtual logical hosts communicate with which virtual logical hosts, which virtualized containers communicate with which virtualized containers, etc.).

At 402, the manifest is analyzed to determine a number of decoy resources and corresponding locations for the decoy resources. A decoy resource may be a virtual logical host or a virtualized container, but does not contribute to the overall objective of the containerized application. A management controller may analyze the manifest and determine where, how many, how long, and the type of decoy resources to deploy a computing node. The management controller may implement a recommendation engine, a rule-based model, a machine learning model, etc., to make the determination. The decoy resource may have a name that is similar (within a threshold amount) to legitimate virtual logical hosts or virtualized containers associated with the containerized application. This may cause a malicious actor to believe that the decoy resource is a legitimate resource of the containerized application.

At 406, one or more virtual logical hosts and one or more decoy resources are deployed. The management controller generates one or more decoy resources and deploys the one or more decoy resources to a computing node at the determined locations. In normal operation of the containerized application, a legitimate virtual logical host or legitimate virtualized container does not communicate with a decoy resource. The main purpose of a decoy resource is to provide a detection mechanism for any malicious activity within the cluster and to divert a malicious actor's focus towards gaining access to the decoy resource instead of the actual sensitive resources in the cluster.

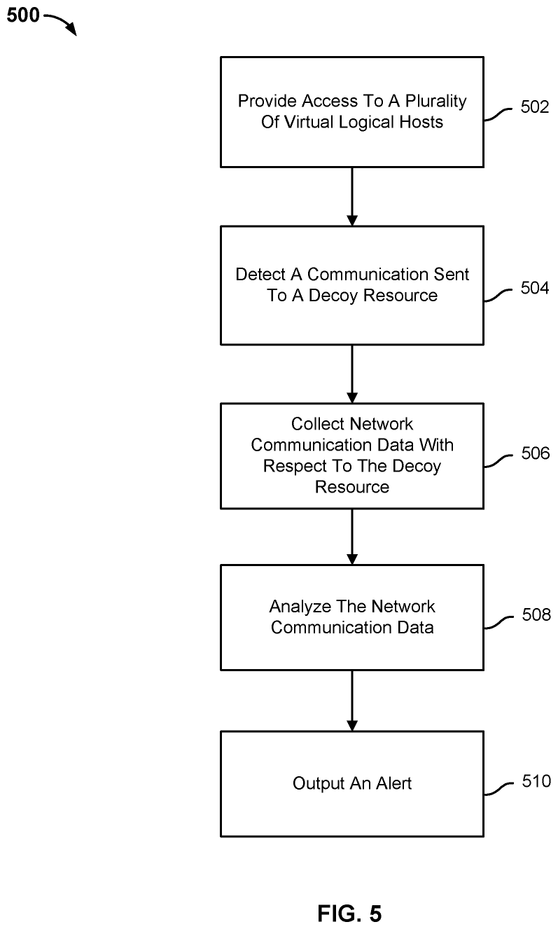

FIG. 5 is a flow chart illustrating a process for detecting malicious activity in a cluster in accordance with some embodiments. In the example shown, process 500 may be implemented by a computing node, such as computing node 101.

At 502, access to a plurality of virtual logical hosts is provided. A plurality of virtual logical hosts are deployed to a cluster comprising one or more computing nodes. In some embodiments, the plurality of virtual logical hosts are deployed to one of the computing nodes. In some embodiments, the plurality of virtual logical hosts are deployed across a plurality of the computing nodes. An endpoint outside of the cluster may access the plurality of virtual logical hosts.

At 504, a communication sent to a decoy resource is detected. A decoy resource may be in communication with at least one of the plurality of virtual logical hosts. In normal operation of the containerized application, a legitimate virtual logical host or legitimate virtualized container does not communicate with a decoy resource.

A device associated with a malicious actor outside of the cluster may access the containerized application. The malicious actor's device may gain access and control of a virtual logical host and/or a virtualized container. The one or more virtual logical hosts and virtualized containers of a containerized application are located on the same network (e.g., subnet). Because the malicious actor is unaware of the containerized application configuration, the malicious actor's device may scan for neighboring virtual logical hosts and/or virtualized containers to determine one or more virtual logical hosts and/or virtualized containers that are in communication with virtual logical host or virtualized container that the malicious actor's device has accessed. The scan may identify the decoy resource and the malicious actor's device may attempt to access the decoy resource by sending a communication to the decoy resource. The malicious actor may believe the decoy resource is a legitimate resource of the containerized application because the name of the decoy resource is similar to other virtual logical hosts and/or virtualized containers of the containerized application.

At 506, network communication data with respect to the decoy resource is collected. In response to a communication, the decoy resource is configured to collect any information associated with a received network communication data. The information may include metadata associated with a received network communication data, such as a source internet protocol (IP) address, a source port, a destination IP address, a destination port, a protocol used, a cluster identity, a namespace identity, a virtualized logical host identity, a label, and/or network metrics associated with the network communication data (e.g., number of bytes and packets), etc. The information may also include the data packets of the network communication data. The decoy resource may provide the management controller the collected information.

At 508, the network communication data is analyzed. A management controller of the computing node may use an IDS engine to analyze the collected information. The IDS engine may extract a payload from the data packets of the network communication data to determine a type of exploit that the malicious actor is attempting to execute on the computing node.

At 510, an alert is outputted. Management controller 215 may store information about the network communication data and/or provide the information about the network communication data to a network security system. The network security system may include a logging system that stores a flow log. The information may be stored in a flow log that includes an entry for each captured data packet. The entry may include information such as source port, destination port, source IP address, destination IP address, packet size, labels, metadata, policy group, etc. The information may be used to identify a malicious actor device, the virtual logical host or virtualized container from which the malicious actor device contacted the decoy resource, determine a type of attack/exploit used by a malicious actor device, determine whether the attack is static or dynamic, etc.

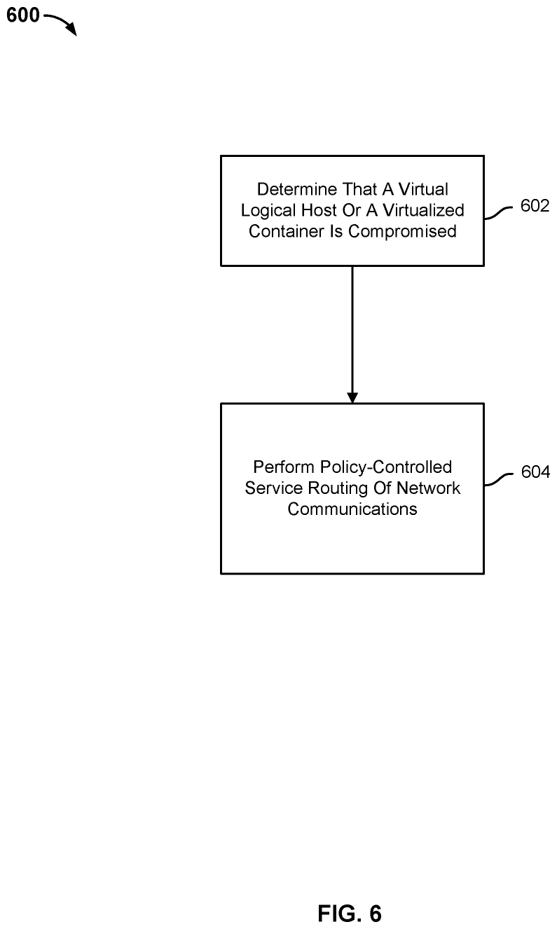

FIG. 6 is a flow chart illustrating a process for performing mitigation actions in accordance with some embodiments. In the example shown, process 600 may be implemented by a computing node, such as computing node 101.

At 602, a virtual logical host or a virtualized container is determined to be compromised. A management controller of a computing device may determine a virtual logical host or a virtualized container from which a communication is sent to a decoy resource. In some embodiments, a single virtual logical host or a single virtualized container is configured to communicate with the decoy resource. Thus, in the event the decoy resource receives a communication, the management controller determines that the single virtual logical host or the single virtualized container is compromised.

In some embodiments, a plurality of virtual logical hosts and/or a plurality of virtualized containers are configured to communicate with the decoy resource. The network communication received at the decoy resource may include metadata that indicates the virtual logical host or virtualized container from which the communication is sent. Thus, in the event the decoy resource receives a communication, the management controller determines that the single virtual logical host or the single virtualized container is compromised based on the metadata included in the network communication.

At 604, policy-controlled service routing of network communications for the compromised virtual logical host or the compromised virtualized container is performed. A compromised virtual logical host or compromised virtualized container may be mitigated through the use of labels and/or policies. In some embodiments, metadata (e.g., tag, label, key-value pair, etc.) is attached the compromised virtual logical host or compromised virtualized container. A policy associated with the attached metadata may indicate that the compromised virtual logical host or compromised virtualized container is not permitted to communicate with other virtual logical hosts or virtualized containers. In some embodiments, metadata is already attached to the compromised virtual logical host or compromised virtualized container and a policy associated with the attached metadata is updated to indicate that a virtual logical host or virtualized container having at least some of the attached metadata is no longer permitted to communicate with other virtual logical hosts or virtualized containers.

For example, a policy associated with a “quarantine” label may be stored in a policy data store. The policy may indicate that any virtual logical host or virtualized container with a “quarantine” label is not permitted to communicate with other virtual logical hosts or virtualized containers of a cluster. An agent of a computing node may be configured to subscribe to updates in a policy data store and update one or more entries of an access control data store that correspond to the compromised virtual logical host or compromised virtualized container.

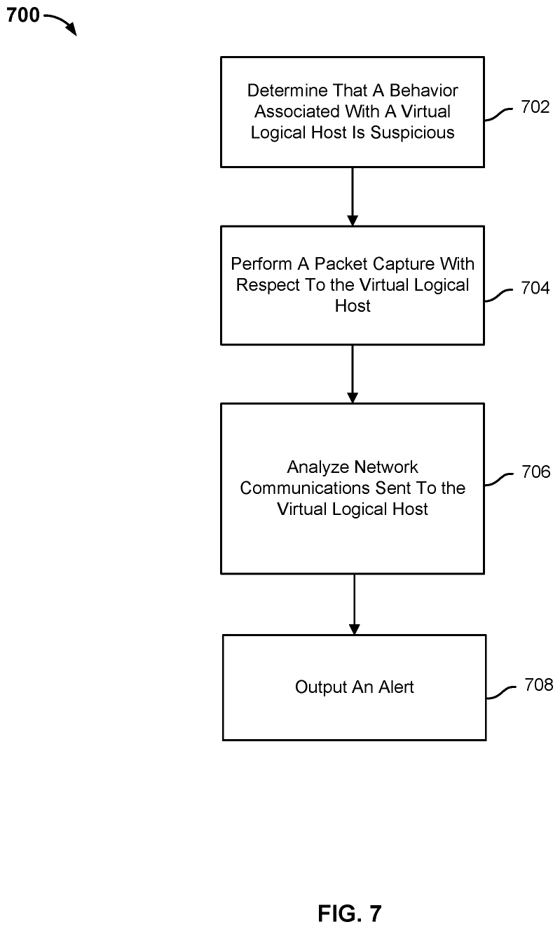

FIG. 7 is a flow chart illustrating a process for selectively network scanning in accordance with some embodiments. In the example shown, process 700 may be implemented by a management controller, such as management controller 165.

At 702, it is determined that a behavior associated with a virtual logical host is suspicious. For example, the amount of network communication data sent from a virtual logical host may exceed a baseline amount by a threshold amount. The type of network communication data sent from a virtual logical host may deviate from an expected type.

A management controller may periodically (e.g., once an hour, once a day, once a week, etc.) monitor the behavior associated with a virtual logical host to determine whether the behavior is suspicious. The management controller may selectively monitor, based on a recommendation from the recommendation engine, the virtual logical host to determine if the virtual logical host has been compromised.

At 704, a packet capture with respect to the virtual logical host is performed. The management controller may tap into a virtual connection (e.g., at a virtual interface associated with frontend resource 306) associated with the virtual logical host and collect network communication data (e.g., capture data packets). The management controller may store information about the data packet and/or provide the information about the data packet to a network security system. The information may be stored in a flow log that stores an entry for each captured data packet. An entry may include information such as source port, destination port, source IP address, destination IP address, packet size, labels, metadata, policy group, etc.

At 706, network communications sent to the virtual logical host is analyzed. An IDS engine of the management controller may analyze the extracted payload. For example, a virtual logical host may receive web traffic and the IDS engine may determine a uniform resource location (URL) associated with the web traffic and/or a hypertext transfer protocol (HTTP) header associated with the web traffic. The payload may include a HTTP GET method, HTTP POST method, or other HTTP methods, and include an exploit. The exploit may include a script. The IDS engine may analyze the payload to determine type of exploit being used.

At 708, an alert is outputted. The management controller may output an alert to a network security system. In response to receiving the alert, a network security system may cause the metadata attached to virtual logical host to be updated. For example, the network security system may send to an orchestrator associated with the system or to the management controller a command to attach a “quarantine” label to the virtual logical host. A policy associated with a “quarantine” label may be stored in a policy data store. The policy may indicate that any virtual logical host or virtualized container with a “quarantine” label is not permitted to communicate with other virtual logical hosts or virtualized containers of the cluster.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a communication interface; and
a processor coupled to the communication interface and configured to:
provide access, via network communications received via the communication interface, to a plurality of virtual logical hosts and a decoy resource, wherein each virtual logical host comprises one or more virtualized containers;
detect a communication sent to the decoy resource; and
collect network communication data with respect to the decoy resource, based at least in part on detecting the communication sent to the decoy resource, wherein the network communication data includes metadata used to provide said access via network communications to the decoy resource.

2. The system of claim 1, wherein the metadata associates a network address used to send the communication with the decoy resource.

3. The system of claim 2, wherein the metadata that associates the network address includes an internet protocol address.

4. The system of claim 1, wherein a subset of the plurality of virtual logical hosts are permitted to communicate with the decoy resource.

5. The system of claim 4, wherein the subset of the plurality of virtual logical hosts are permitted to communicate with the decoy resource based on metadata attached to the subset of the plurality of virtual logical hosts.

6. The system of claim 5, wherein the metadata attached to the subset of the plurality of virtual logical hosts includes at least one of a tag, a label, or a key-value pair.

7. The system of claim 1, wherein a subset of the plurality of virtual logical hosts that are permitted to communicate with the decoy resource are determined based on a manifest associated with a deployment of the plurality of virtual logical hosts.

8. The system of claim 7, wherein the processor is further configured to generate and deploy the decoy resource based on an analysis of the manifest associated with the deployment of the plurality of virtual logical hosts.

9. The system of claim 8, wherein the analysis is performed by a recommendation engine.

10. The system of claim 1, wherein the processor is further configured to analyze the network communication data.

11. The system of claim 10, wherein the processor is configured to identify a compromised virtual logical host based on an analysis of the network communication data.

12. The system of claim 1, wherein the processor is further configured to output an alert indicating that one of the virtual logical hosts is compromised.

13. The system of claim 1, wherein a policy associated with a compromised virtual logical host is modified to prevent the compromised virtual logical host from communicating with other virtual logical hosts of the plurality of virtual logical hosts.

14. The system of claim 1, wherein additional metadata is attached to a compromised virtual logical host of the plurality of virtual logical hosts.

15. The system of claim 1, wherein the decoy resource is a virtual logical host.

16. The system of claim 1, wherein the decoy resource is a virtualized container.

17. The system of claim 1, wherein the processor is further configured to selectively monitor network communications data associated with one of the plurality of virtual logical hosts.

18. The system of claim 17, wherein the processor is further configured to determine that the one of the plurality of virtual logical hosts is a compromised virtual logical host based on the monitored network communications data.

19. A method, comprising:
providing access, via network communications received via a communication interface, to a plurality of virtual logical hosts and a decoy resource, wherein each virtual logical host comprises one or more virtualized containers;
detecting a communication sent to the decoy resource; and
collecting network communication data with respect to the decoy resource, based at least in part on detecting the communication sent to the decoy resource, wherein the network communication data includes metadata used to provide said access via network communications to the decoy resource.

20. A computer program product, the computer program product being embodied in a non-transitory computer readable storage medium and comprising computer instructions for:
providing access, via network communications received via a communication interface, to a plurality of virtual logical hosts and a decoy resource, wherein each virtual logical host comprises one or more virtualized containers;
detecting a communication sent to the decoy resource; and
collecting network communication data with respect to the decoy resource, based at least in part on detecting the communication sent to the decoy resource, wherein the network communication data includes metadata used to provide said access via network communications to the decoy resource.
